(19) United States
(12) Patent Application Publication
(10) Pub. No.: US 2014/0134502 A1
(43) Pub. Date: May 15, 2014

(54) ELECTROLYTE FOR SECONDARY LITHIUM BATTERY AND SECONDARY LITHIUM BATTERY USING THE SAME

(71) Applicants: SAMSUNG FINE CHEMICALS CO., LTD., Ulsan (KR); SAMSUNG SDI CO., LTD., Yongin-si (KR)

(72) Inventors: Yoon-sok KANG, Seongnam-si, Gyeonggi-do (KR); Min-sik PARK, Hwaseong-si, Gyeonggi-do (KR); Jun-young MUN, Seoul (KR)

(73) Assignees: SAMSUNG FINE CHEMICALS CO., LTD., Ulsan (KR); SAMSUNG SDI CO., LTD., Yongin-si (KR)

(21) Appl. No.: 13/954,465

(22) Filed: Jul. 30, 2013

(30) Foreign Application Priority Data
Nov. 9, 2012 (KR) 10-2012-0126949

(51) Int. Cl. H01M 10/0567; H01M 10/0525

(52) U.S. Cl. CPC H01M 10/0567; H01M 10/0525
USPC 429/341; 429/188; 429/199

(57) ABSTRACT

An electrolyte for a lithium secondary battery, the electrolyte including a lithium salt; a nonaqueous organic solvent; and an additive composition, wherein the additive composition comprises at least one of a first compound of Formula 1 and a second compound of Formula 2:

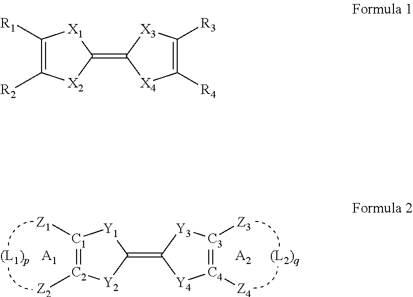

wherein A₁, A₂, C₁ to C₄, R₁ to R₄, X₁ to X₄, Y₁ to Y₄, Z₁ to Z₄, L₁, L₂, p, and q are defined in the specification.

### CROSS-REFERENCE TO RELATED APPLICATIONS

This application claims priority to and the benefit of Korean Patent Application No. 10-2012-0126949, filed on Nov. 9, 2012, and all the benefits accruing therefrom under 35 U.S.C. §119, the content of which is incorporated herein in its entirety by reference.

### BACKGROUND

1. Field

The present disclosure relates to an electrolyte for a lithium secondary battery, and a lithium secondary battery including the electrolyte.

2. Description of the Related Art

Lithium ions batteries (“LIBs”) have high energy density per unit weight and can be easily designed. Thus, these batteries have been developed for use in small electronic devices and portable IT devices. In recent years, small-medium sized lithium ion batteries have drawn attention as power sources for electric vehicles and power storage devices storing electricity produced as alternate.

A lithium secondary battery includes a cathode, an anode, and a separator. During discharging of the lithium secondary battery, oxidation reaction occurs in the anode due to deintercalation of lithium ions, while reduction reaction occurs in the cathode due to intercalation of lithium ions, and vice versa during charging. The electrolyte has conductivity only for ions, not for electrons, and thus transfers lithium ions between the cathode and the anode.

Lithium ions intercalated into an electrode of a battery lead to charge neutrality with electrons entered into the electrode, and thus serve as media storing electric energy in the electrode. Accordingly, the quantity of electric energy storable by the battery is dependent upon the quantity of lithium ions intercalated into the electrode for the charge neutrality. Although basic performance of the lithium secondary battery, such as operating voltage and energy density, is dependent upon the materials of the cathode and anode, the electrolyte also needs to have high-ion conductivity, electrochemical stability, and thermal stability for high performance of the lithium secondary battery.

An electrolyte consists of a lithium salt and an organic solvent. The electrolyte needs to be electrochemically stable in a voltage range where reduction and oxidation proceed in the anode and cathode, respectively.

With the expanding use of lithium secondary batteries in the electric vehicle and power storage fields, electrode active materials for use at high voltages have become available. Use of a relatively low-potential anode active material and a relatively high-potential cathode active material has led to a narrower potential window of the electrolyte, so that the electrolyte becomes more likely to decompose on a surface of the cathode/anode. Lithium secondary batteries for electric vehicles and power storage are likely to be exposed to external high-temperature environment conditions, and the temperatures of these lithium secondary batteries may rise during instantaneous charging and discharging. Accordingly, lifetime and stored energy quantity of the lithium secondary battery may be reduced in such high-temperature environment conditions.

Therefore, there is a demand for the development of an electrolyte composition that would provide improved lifetime and high-rate characteristics of the lithium secondary batteries.

### SUMMARY

Provided is an electrolyte for a lithium secondary battery that is resistant to oxidation on a surface of cathode, and that provides improved lifetime characteristics and high-rate characteristics.

Provided is a lithium secondary battery with improved lifetime characteristics and high-rate characteristics, the lithium secondary battery including the electrolyte.

Additional aspects will be set forth in part in the description which follows and, in part, will be apparent from the description, or may be learned by practice of the presented embodiments.

According to an aspect of the present disclosure, an electrolyte for a lithium secondary battery includes:

a lithium salt;
a nonaqueous organic solvent; and
an additive composition,
wherein the additive composition includes at least one of a first compound of Formula 1 below and a second compound of Formula 2 below:

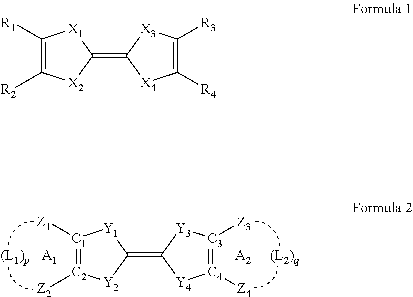

wherein, in Formulae 1 and 2,
X₁ to X₄, and Y₁ to Y₄ are each independently selected from oxygen (O), sulfur (S), selenium (Se), or tellurium (Te);
A₁ and A₂ each indicates a ring;
Z₁ to Z₄ are each independently selected from, —O— —S—, —Se—, —Te—, —C(═O)—, —C(R₁₁)(R₁₂)—, —C(R₁₃)═, and —N(R₁₄)—;
L₁ and L₂ are each independently selected from ═C(R₂₁)—C(R₂₂)═, —C(R₂₃)(R₂₄)—, —C(R₂₅)═C(R₂₆)—, —C(R₂₇)═, and —C(═O)—;
p and q are each independently an integer from 1 to 5, wherein,
when p is 2 or greater, groups L₁ are each identical to or different from each other, and
when q is 2 or greater, groups L₂ are each identical to or different from each other;
R₁ to R₄, R₁₁ to R₁₄, and R₂₁ to R₂₇ are each independently selected from, a hydrogen atom, a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a substituted or unsubstituted C₁-C₆₀ alkyl group, a substituted or unsubstituted C₁-C₆₀ alkoxy group, a substituted or unsubstituted C₁-C₆₀ heteroalkyl group, a substituted or unsubstituted C₂-C₆₀ alkenyl group, a substituted or unsubstituted C₂-C₆₀ alkynyl group, a substituted or unsubstituted C₃-C₁₀ cycloalkyl group, a substituted or unsubstituted C₃-C₁₀ heterocycloalkyl group, a substituted or unsubstituted C₂-C₁₀ cycloalkenyl group, a substituted or unsubstituted C₂-C₁₀ heterocycloalkenyl group, a substituted or unsubstituted C₆-C₆₀ aryl group, a substituted or unsubstituted C₆-C₆₀ aryloxy group, a substituted or unsubstituted C₂-C₆₀ heteroaryl group, -(Q₁)ᵣ(Q₂)ₛ, —N(Q₃)(Q₄)(Q₅), —P(═O)(Q₆)(Q₇), and —P(Q₈)(Q₉)(Q₁₀)(Q₁₁);
optionally, wherein at least one of R₁₁ to R₁₄ and at least one of R₂₁ to R₂₇ are linked to each other to form a substituted or unsubstituted, saturated or unsaturated ring Q₁ is at least one selected from —O—, —S—, —C(═O)—, a substituted or unsubstituted C₁-C₆₀ alkylene group, a substituted or unsubstituted C₂-C₆₀ alkenylene group, a substituted or unsubstituted C₃-C₁₀ cycloalkylene group, a substituted or unsubstituted C₃-C₁₀ heterocycloalkylene group, a substituted or unsubstituted C₂-C₁₀ cycloalkenylene group, a substituted or unsubstituted C₂-C₁₀ heterocycloalkenylene group, a substituted or unsubstituted C₆-C₆₀ arylene group, and a substituted or unsubstituted C₂-C₆₀ heteroarylene group;
Q₂ to Q₁₁ are each independently selected from a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, a substituted or unsubstituted C₁-C₆₀ alkyl group, a substituted or unsubstituted C₁-C₆₀ alkoxy group, a substituted or unsubstituted C₁-C₆₀ heteroalkyl group, a substituted or unsubstituted C₂-C₆₀ alkenyl group, a substituted or unsubstituted C₂-C₆₀ alkynyl group, a substituted or unsubstituted C₃-C₁₀ cycloalkyl group, a substituted or unsubstituted C₃-C₁₀ heterocycloalkyl group, a substituted or unsubstituted C₂-C₁₀ cycloalkenyl group, a substituted or unsubstituted C₂-C₁₀ heterocycloalkenyl group, a substituted or unsubstituted C₆-C₆₀ aryl group, a substituted or unsubstituted C₆-C₆₀ aryloxy group, and a substituted or unsubstituted C₂-C₆₀ heteroaryl group;
r and s are each independently an integer from 1 to 5, wherein,
when r is 2 or greater, groups Q₁ are each identical to or different from each other, and
when s is 2 or greater, groups Q₂ are each identical to or different from each other; and C₁, C₂, C₃, and C₄ indicate positions of carbon atoms.

According to another aspect of the present disclosure, a lithium secondary battery include:

a cathode including a cathode active material that allows intercalation and deintercalation of lithium;
an anode including an anode active material that allows intercalation and deintercalation of lithium; and
an electrolyte disposed between the cathode and the anode,
wherein the electrolyte is the above-described electrolyte.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic cross-sectional view illustrating a thin film formed on a surface of a cathode of a lithium secondary battery according to an embodiment;

FIG. 2 is an exploded perspective view of a lithium secondary battery according to an embodiment;

FIG. 3 is a graph of discharge capacity (milliAmpere×hour per gram, mA×h/g) versus cycle number showing discharge capacities of the batteries of Comparative Example B and Example 1;

FIG. 4 is a graph of capacity retention rate (percent, %) versus cycle number showing capacity retention rates of the batteries of Comparative Examples A and B and Example 1;

FIG. 5 is a graph of discharge capacity (milliAmpere×hour per gram, mA×h/g) versus cycle number showing high-rate characteristics of the batteries of Comparative Example and B and Example 1;

FIG. 6 is a scanning electron microscopy (“SEM”) image of a cathode surface of the battery of Example 1 after 300^{th} charge and discharge cycle at 45° C.; and

FIG. 7 is a graph of intensity (arbitrary units, a.u.) versus binding energy (electron Volt, eV) illustrating X-ray photoelectron spectra of cathode surface material from the batteries of Example 1 and Comparative Example B after 300^{th} charge and discharge cycle.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Substituents in the formulae below may be defined as follows.

As used herein, the term “alkyl” indicates a monovalent or higher valency group derived from a completely saturated, branched or unbranched (or a straight or linear) hydrocarbon, and having the specified number of carbon atoms.

Non-limiting examples of the “alkyl” group are methyl, ethyl, n-propyl, isopropyl, n-butyl, isobutyl, sec-butyl, t-butyl, isopentyl, neopentyl, n-hexyl, 3-methylhexyl, 2,2-dimethylpentyl, 2,3-dimethylpentyl, and n-heptyl.

At least one hydrogen atom of an alkyl group or any of the groups below may be substituted with a halogen atom, a C₁-C₁₀ alkyl group substituted with a halogen atom (for example, CCF₃, CHCF₂, CH₂F, CCl₃, and the like), a C₁-C₁₀ alkoxy group, a hydroxyl group (—OH), a nitro group (—NO₂), a cyano group (—CN), an amino group (—NRR′, wherein R and R′ are independently hydrogen or a C₁-C₁₀ alkyl group), an amido group (—C(═O)NRR′, wherein R and R′ are independently hydrogen or a C₁-C₁₀ alkyl group), a hydrazine group (—NHNRR′, wherein R and R′ are independently hydrogen or a C₁-C₁₀ alkyl group), a hydrazone group (—CR═NHNR′R″, wherein R, R′ and R″ are independently hydrogen or a C₁-C₁₀ alkyl group), an azido group (—N₃), an amidino group (—C(═NH)NRR′ wherein R and R′ are independently hydrogen or a C₁-C₁₀ alkyl group), a carboxyl group (—CO₂H) or a salt thereof, a sulfonyl group, a sulfamoyl group, a sulfonic acid group (—SO₃H) or a salt thereof, a phosphoric acid group (—P(═O)(OH)₂) or a salt thereof, a C₁-C₁₀ alkyl group, a C₂-C₁₀ alkenyl group, a C₂-C₁₀ alkynyl group, a C₁-C₁₀ heteroalkyl group, a C₆-C₁₀ aryl group, or a C₂-C₁₀ heteroaryl group.

Combinations of substituents and/or variables are permissible only if such combinations result in stable compounds or useful synthetic intermediates. A stable compound or stable structure is meant to imply a compound that is sufficiently robust to survive isolation from a reaction mixture.

As used herein, the term “halogen atom” indicates fluorine, bromine, chlorine, iodine, and the like.

As used herein, the term “cycloalkyl” indicates a saturated hydrocarbon ring group, having only carbon ring atoms and having the specified number of carbon atoms. A non-limiting example of a cycloalkyl group includes cyclohexyl.

As used herein, the term “heterocycloalkyl” indicates a saturated hydrocarbon ring group, including at least one heteroatom selected from nitrogen (N), oxygen (O), phosphorous (P), and sulfur (S), wherein the rest of the cyclic atoms are carbon, and having the specified number of carbon atoms. A non-limiting example of a heterocycloalkyl group includes tetrahydro-2H-pyran-2-yl (C₅H₉O—).

As used herein, the term “heteroalkyl” indicates an alkyl group, including at least one heteroatom selected from nitrogen (N), oxygen (O), phosphorous (P), and sulfur (S), and having the specified number of carbon atoms. A non-limiting example of a heteroalkyl group includes methylthiomethyl (CH₃SCH₂—).

As used herein, the term “alkenyl” indicates a monovalent group derived from a straight or branched chain saturated aliphatic hydrocarbon, having at least one double bond, and having the specified number of carbon atoms. Non-limiting examples of the alkenyl groups include ethenyl, propenyl, isopropenyl, and hexenyl.

As used herein, the term “cycloalkenyl” indicates a saturated hydrocarbon ring group, having only carbon ring atoms, including at least one double bond, and having the specified number of carbon atoms. A non-limiting example of a cycloalkenyl group includes cyclohex-1-en-3-yl.

As used herein, the term “heterocycloalkenyl” indicates a saturated hydrocarbon ring group, having at least one heteroatom selected from nitrogen (N), oxygen (O), phosphorous (P), and sulfur (S), wherein the rest of the cyclic atoms are carbon, including at least one double bond, and having the specified number of carbon atoms. A non-limiting example of a heterocycloalkenyl group includes 3,6-dihydro-2H-pyran-2-yl (C₅H₇O—).

As used herein, the term “alkynyl” indicates a monovalent group derived from a straight or branched chain saturated aliphatic hydrocarbon, having at least one triple bond, and having the specified number of carbon atoms. Non-limiting examples of the alkynyl groups include ethynyl and propynyl.

As used herein, the term “alkoxy” indicates “alkyl-O—”, wherein the alkyl is the same as described above and having the specified number of carbon atoms. Non-limiting examples of the alkoxy group include methoxy, ethoxy, propoxy, 2-propoxy, butoxy, t-butoxy, pentyloxy, hexyloxy, cyclopropoxy, and cyclohexyloxy.

As used herein, the term “aryl” group, which is used alone or in combination, indicates a monovalent group derived from an aromatic hydrocarbon containing at least one ring, and having the specified number of carbon atoms. As used herein, the term “aryl” is construed as including a group with an aromatic ring fused to at least one cycloalkyl ring. Non-limiting examples of the “aryl” group include phenyl, naphthyl, and tetrahydronaphthyl.

As used herein, the term “aryloxy” indicates “—O-aryl” having the specified number of carbon atoms. A non-limiting example of the aryloxy group is phenoxy.

As used herein, the term “heteroaryl group” indicates a monovalent group derived from a monocyclic or bicyclic aromatic organic compound including at least one heteroatom selected from nitrogen (N), oxygen (O), phosphorous (P), and sulfur (S), wherein the rest of the cyclic atoms are carbon, and having the specified number of carbon atoms. The heteroaryl group may include, for example, one to five heteroatoms, and in some embodiments, may include a five- to ten-membered ring. In the heteroaryl group, S or N may be present in various oxidized forms.

Non-limiting examples of a monocyclic heteroaryl group include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiaxolyl, 1,2,3-thiadiazolyl, 1,2,4-thiadiazolyl, 1,2,5-thiadiazolyl, 1,3,4-thiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, and 5-pyrimidin-2-yl.

As used herein, the term “heteroaryl” is construed to include a heteroaromatic ring fused to at least one of an aryl group, a carbocyclic group, and a heterocyclic group.

Non-limiting examples of a bicyclic heteroaryl group are indolyl, isoindolyl, indazolyl, indolizinyl, purinyl, quinolizinyl, quinolinyl, isoquinolinyl, cinnolinyl, phthalazinyl, naphthyridinyl, quinazolinyl, quinaxalinyl, phenanthridinyl, phenathrolinyl, phenazinyl, phenothiazinyl, phenoxazinyl, benzisoqinolinyl, thieno[2,3-b]furanyl, furo[3,2-b]-pyranyl, 5H-pyrido[2,3-d]-o-oxazinyl, 1H-pyrazolo[4,3-d]-oxazolyl, 4H-imidazo[4,5-d]thiazolyl, pyrazino[2,3-d]pyridazinyl, imidazo[2,1-b]thiazolyl, imidazo[1,2-b][1,2,4]triazinyl, 7-benzo[b]thienyl, benzoxazolyl, benzimidazolyl, benzothiazolyl, benzoxapinyl, benzoxazinyl, 1H-pyrrolo[1,2-b][2]benzazapinyl, benzofuryl, benzothiophenyl, benzotriazolyl, pyrrolo[2,3-b]pyridinyl, pyrrolo[3,2-c]pyridinyl, pyrrolo[3,2-b]pyridinyl, imidazo[4,5-b]pyridinyl, imidazo[4,5-c]pyridinyl, pyrazolo[4,3-d]pyridinyl, pyrazolo[4,3-c]pyridinyl, pyrazolo[3,4-c]pyridinyl, pyrazolo[3,4-d]pyridinyl, pyrazolo[3,4-b]pyridinyl, imidazo[1,2-a]pyridinyl, pyrazolo[1,5-a]pyridinyl, pyrrolo[1,2-b]pyridazinyl, imidazo[1,2-c]pyrimidinyl, pyrido[3,2-d]pyrimidinyl, pyrido[4,3-d]pyrimidinyl, pyrido[3,4-d]pyrimidinyl, pyrido[2,3-d]pyrimidinyl, pyrido[2,3-b]pyrazinyl, pyrido[3,4-b]pyrazinyl, pyrimido[5,4-d]pyrimidinyl, pyrazino[2,3-b]pyrazinyl, and pyrimido[4,5-d]pyrimidinyl.

As used herein, the term “alkylene” indicates a straight or branched divalent aliphatic hydrocarbon group having the specified number of carbon atoms. Non-limiting examples of the alkylene group include methylene, ethylene, propylene, and butylene.

As used herein, the term “alkenylene” indicates a straight or branched chain, divalent hydrocarbon group having at least one carbon-carbon double bond, and having the specified number of carbon atoms. A non-limiting example of the alkenylene group includes propenylene.

As used herein, the term “cycloalkylene” indicates a cyclic divalent aliphatic hydrocarbon group having the specified number of carbon atoms. Non-limiting examples of the cycloalkylene group include cyclopropylene, cyclobutylene, cyclopentylene, and cyclohexylene.

As used herein, the term “heterocycloalkylene” indicates a cyclic divalent aliphatic hydrocarbon group, including at least one heteroatom selected from nitrogen (N), oxygen (O), phosphorous (P), and sulfur (S), wherein the rest of the cyclic atoms are carbon, and having the specified number of carbon atoms. A non-limiting example of a heterocycloalkylene group includes tetrahydro-2H-pyran-2,5-ylene (C₅H₈O—).

As used herein, the term “cycloalkenylene” indicates a cyclic divalent aliphatic hydrocarbon group including at least one double bond and having the specified number of carbon atoms. A non-limiting examples of the cycloalkenylene group include cycloprop-1-en-1,2-ylene.

As used herein, the term “heterocycloalkenylene” indicates a cyclic divalent aliphatic hydrocarbon group, including at least one heteroatom selected from nitrogen (N), oxygen (O), phosphorous (P), and sulfur (S), wherein the rest of the cyclic atoms are carbon, including at least one double bond, and having the specified number of carbon atoms. A non-limiting example of a heterocycloalkylene group includes 3,6-dihydro-2H-pyran-2,5-ylene (C₅H₈O—).

As used herein, the term “arylene” means a divalent group formed by the removal of two hydrogen atoms from one or more rings of an arene, wherein the hydrogen atoms may be removed from the same or different rings. Non-limiting examples of the arylene group include phenylene or napthylene.

As used herein, the term “heteroarylene” means a divalent group formed by the removal of two hydrogen atoms from one or more rings of a heteroaryl moiety, wherein the hydrogen atoms may be removed from the same or different rings, each of which rings may be aromatic or nonaromatic. A non-limiting example of the heteroarylene group includes pyrid-2,5-ylene.

The term “sulfonyl” indicates R″—SO₂—, wherein R″ is a hydrogen atom, alkyl, aryl, heteroaryl, alkoxy, aryloxy, cycloalkyl, or a heterocyclic group.

The term “sulfamoyl” group indicates H₂NS(O₂)—, alkyl-NHS(O₂)—, (alkyl)₂NS(O₂)— aryl-NHS(O₂)—, (aryl)₂NS(O)₂, or heteroaryl-NHS(O₂)—.

According to an embodiment of the inventive concept, an electrolyte for a lithium secondary battery includes

a lithium salt,
a nonaqueous organic solvent, and
an additive composition,
wherein the additive composition includes at least one of a first compound represented by Formula 1 below and a second compound represented by Formula 2 below:

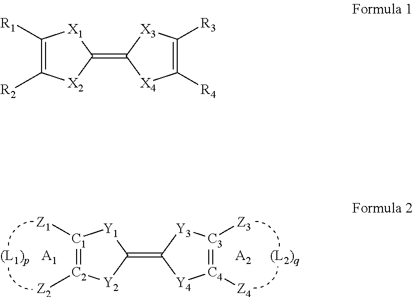

The additive composition may include

the first compound of Formula 1,
the second compound of Formula 2, or
both the first compound of Formula 1 and the second compound of Formula 2.

The additive composition may include the first compound of Formula 1.

In Formula 1, X₁ to X₄ are each independently selected from oxygen (O), sulfur (S), selenium (Se), or tellurium (Te).

In some embodiments, in Formula 1,

X₁ to X₄ may each independently be S or Se, but are not limited thereto.

In Formula 1,

R₁ to R₄ may be each independently selected from a hydrogen atom, a deuterium atom, a halogen atom, a hydroxyl group (—OH), a cyano group, a nitro group, an azido group, an amino group, an amido group, an amidino group, a hydrazine, a hydrazone, a carboxyl group or a salt thereof, a sulfonic acid group or a salt thereof, a phosphoric acid group or a salt thereof, a thiol group (—SH), —C(═O)—H, a substituted or unsubstituted C₁-C₆₀ alkyl group, a substituted or unsubstituted C₁-C₆₀ alkoxy group, a substituted or unsubstituted C₁-C₆₀ heteroalkyl group, a substituted or unsubstituted C₂-C₆₀ alkenyl group, a substituted or unsubstituted C₂-C₆₀ alkynyl group, a substituted or unsubstituted C₃-C₁₀ cycloalkyl group, a substituted or unsubstituted C₃-C₁₀ heterocycloalkyl group, a substituted or unsubstituted C₂-C₁₀ cycloalkenyl group, a substituted or unsubstituted C₂-C₁₀ heterocycloalkenyl group, a substituted or unsubstituted C₆-C₆₀ aryl group, a substituted or unsubstituted C₆-C₆₀ aryloxy group, a substituted or unsubstituted C₂-C₆₀ heteroaryl group, -(Q₁)ᵣ-(Q₂)ₛ, —N(Q₃)(Q₄)(Q₅), —P(═O)(Q₆)(Q₇), and —P(Q₈)(Q₉)(Q₁₀)(Q₁₁), wherein
Q₁ may be selected from —O—, —S—, —C(═O)—, a substituted or unsubstituted C₁-C₆₀ alkylene group, a substituted or unsubstituted C₂-C₆₀ alkenylene group, a substituted or unsubstituted C₃-C₁₀ cycloalkylene group, a substituted or unsubstituted C₃-C₁₀ heterocycloalkylene group, a substituted or unsubstituted C₂-C₁₀ cycloalkenylene group, a substituted or unsubstituted C₂-C₁₀ heterocycloalkenylene group, a substituted or unsubstituted C₆-C₆₀ arylene group, and a substituted or unsubstituted C₂-C₆₀ heteroarylene group;
Q₂ to Q₁₁ may be each independently selected from a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), a substituted or unsubstituted C₁-C₆₀ alkyl group, a substituted or unsubstituted C₁-C₆₀ alkoxy group, a substituted or unsubstituted C₁-C₆₀ heteroalkyl group, a substituted or unsubstituted C₂-C₆₀ alkenyl group, a substituted or unsubstituted C₂-C₆₀ alkynyl group, a substituted or unsubstituted C₃-C₁₀ cycloalkyl group, a substituted or unsubstituted C₃-C₁₀ heterocycloalkyl group, a substituted or unsubstituted C₂-C₁₀ cycloalkenyl group, a substituted or unsubstituted C₂-C₁₀ heterocycloalkenyl group, a substituted or unsubstituted C₆-C₆₀ aryl group, a substituted or unsubstituted C₆-C₆₀ aryloxy group, and a substituted or unsubstituted C₂-C₆₀ heteroaryl group; and
r and s may be each independently an integer from 1 to 5.

When r is 2 or greater, group Q₁ may each be identical to or different from each other. When s is 2 or greater, group Q₂ may each be identical to or different from each other.

In some embodiments, in Formula 1,

R₁ to R₄ may be each independently selected from a hydrogen atom, a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a methyl group, an ethyl group, an n-propyl group, an isopropyl group, an n-butyl group, an isobutyl group, a sec-a butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and -(Q₁)ᵣ-(Q₂)ₛ, wherein
Q₁ may be selected from —O—, —S—, —C(═O)—, a C₁-C₁₀ alkylene group, a C₆-C₁₄ arylene group, and a C₂-C₁₄ heteroarylene group; and
Q₂ may be selected from a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and a C₁-C₁₀ alkoxy group, but are not limited thereto.

In some other embodiments, in Formula 1,

R₁ to R₄ may be each independently selected from a hydrogen atom, a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thio group (—SH), —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, a n-decyl group, an isodecyl group, a sec-decyl group, a tert-decyl group, and the groups represented by Formulae 3A and 3B, but are not limited thereto:

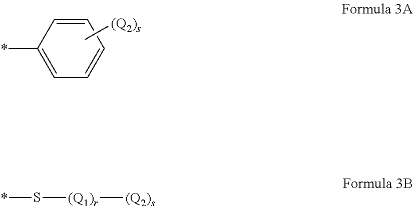

In Formulae 3A and 3B,

Q₁ may be a C₁-C₁₀ alkylene group;
Q₂ may be selected from a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, a and a C₁-C₁₀ alkoxy group; and
r and s may each independently be an integer of 1, 2, or 3.

In Formula 1, R₁ may be not a hydrogen atom; and R₂, R₃, and R₄ may be hydrogen atoms.

In Formula 1, R₁ and R₃ may be not a hydrogen atom, and R₂ and R₄ may be hydrogen atoms.

In Formula 1, R₁ and R₄ may be not hydrogen atoms; and R₂ and R₃ may be hydrogen atoms.

In Formula 1, R₁ to R₄ may be not hydrogen atoms.

The additive composition may include the second compound of Formula 2.

In Formula 2,

A₁ and A₂ each indicates a ring;
Y₁ to Y₄ may be each independently, oxygen (O), sulfur (S), selenium (Se), or tellurium (Te);
Z₁ to Z₄ may be each independently selected from —O— —S—, —Se—, —Te—, —C(═O)—, —C(R₁₁)(R₁₂)—, —C(R₁₃)═, and
—N(R₁₄)—; L₁ and L₂ may be each independently selected from ═C(R₂₁)—C(R₂₂)═, —C(R₂₃)(R₂₄)—, —C(R₂₅)═C(R₂₆)—, —C(R₂₇)=, and —C(═O)— optionally, wherein at least one of R₁₁ to R₁₄ and at least one of R₂₁ to R₂₇ are linked to each other to form a substituted or unsubstituted, saturated or unsaturated ring; and
p and q may be each independently an integer from 1 to 5.

When p is 2 or greater, L₁ may each be identical to or different from each other.

When q is 2 or greater, L₂ may each be identical to or different from each other.

In Formula 2,

R₁₁ to R₁₄, and R₂₁ to R₂₇ may be each independently selected from a hydrogen atom, a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a substituted or unsubstituted C₁-C₆₀ alkyl group, a substituted or unsubstituted C₂-C₆₀ alkenyl group, a substituted or unsubstituted C₂-C₆₀ alkynyl group, a substituted or unsubstituted C₃-C₁₀ cycloalkyl group, a substituted or unsubstituted C₃-C₁₀ heterocycloalkyl group, a substituted or unsubstituted C₂-C₁₀ cycloalkenyl group, a substituted or unsubstituted C₂-C₁₀ heterocycloalkenyl group, a substituted or unsubstituted C₆-C₆₀ aryl group, a substituted or unsubstituted C₂-C₆₀ heteroaryl group, -(Q₁)ᵣ-(Q₂)ₛ, —N(Q₃)(Q₄)(Q₅), —P(═O)(Q₆)(Q₇), and —P(Q₈)(Q₉)(Q₁₀)(Q₁₁),
wherein Q₁ to Q₁₁, r, and s are as defined above; and C₁, C₂, C₃, and C₄ indicate positions of carbon atoms.

In some other embodiments, in Formula 2,

Y₁ to Y₄ may be each independently S or Se;
Z₁ to Z₄ may be each independently selected from —S—, —C(R₁₁)(R₁₂)—, and —C(R₁₃)═;
R₁₁ to R₁₃ may be each independently selected from a hydrogen atom, a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and a C₂-C₁₀ alkenyl group, but are not limited thereto.

In Formula 2,

-(L₁)ₚ- and -(L₂)_{q}- may be each independently selected from the groups represented by Formulae 4A to 4F:

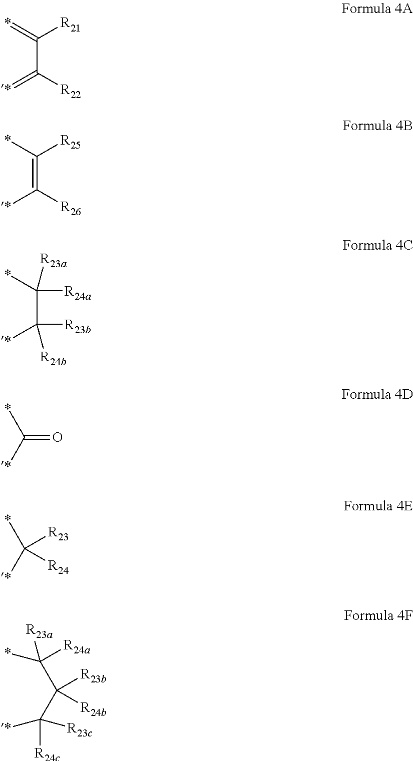

In Formulae 4A to 4F,

* indicates a binding site with Z₁ or Z₃;

### *′ indicates a binding site with Z₂ or Z₄;

R₂₁, R₂₂, R₂₃, R₂₄, R₂₃ₐ, R_{23b}, R_{23c}, R₂₄ₐ, R_{24b}, R_{24c}, R₂₅, and R₂₆ may be each independently selected from a hydrogen atom, a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, a C₂-C₁₀ alkenyl group, and -(Q₁)ᵣ-(Q₂)ₛ, wherein Q₁ may be selected from —O—, —S—, —C(═O)—, a C₁-C₁₀ alkylene group, a C₆-C₁₄ arylene group, and a C₂-C₁₄ heteroarylene group; Q₂ may be selected from a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and a C₁-C₁₀ alkoxy group.

R₂₃ₐ, R_{23b}, and R_{23c} are defined herein the same as R₂₃. R₂₄ₐ, R_{24b}, and R_{24c} are defined herein the same as R₂₄.

In Formula 2, at least one of Z₁ to Z₄ may be selected from —C(R₁₁)(R₁₂)—, —C(R₁₃)═, and —N(R₁₄)—.

In Formula 2, at least one of L₁ and L₂ may be selected from ═C(R₂₁)—C(R₂₂)=, —C(R₂₃)(R₂₄)—, —C(R₂₅)═C(R₂₆)—, and —C(R₂₇)═; and at least one of R₁₁ to R₁₄ and at least one of R₂₁ to R₂₇ may be linked to each other to form a substituted or unsubstituted, saturated or unsaturated ring.

The saturated or unsaturated ring may be selected from a benzene ring, naphthalene ring, and an anthracene ring; and a benzene ring, a naphthalene ring, and an anthracene ring that are substituted with at least one of a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, a C₂-C₁₀ alkenyl group, and -(Q₁)ᵣ-(Q₂)ₛ (where Q₁ may be selected from —O—, —S—, —C(═O)—, C₁-C₁₀ alkylene group, a C₆-C₁₄ arylene group, and a C₂-C₁₄ heteroarylene group; Q₂ may be selected from a deuterium atom, a halogen atom, a hydroxyl group (—OH), a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group (—SH), —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonenyl group, an n-decyl group, an isodecyl group, a sec-decyl group, a tert-decyl group, and a C₁-C₁₀ alkoxy group; and r and s may be each independently an integer from 1 to 5, but are not limited thereto).

For example, in Formula 2, the A₁ ring may be represented by Formula 5A below, and the A₂ ring may be represented by Formula 5B below, but not limited thereto:

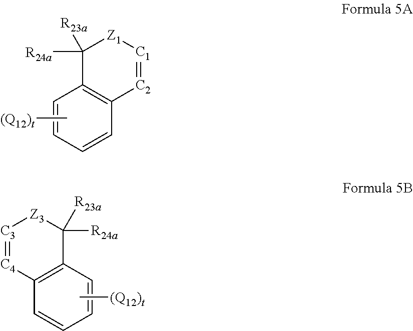

In Formulae 5A and 5B, C₁, C₂, C₃, C₄, Z₁, Z₃, R₂₃ₐ, and R₂₄ₐ are as defined above, descriptions for Q₁₂ may be same as the descriptions for R₂₃ₐ; and

t is an integer from 1 to 4.

The additive composition may include at least one of Compounds 1 to 17 below, but is not limited thereto:

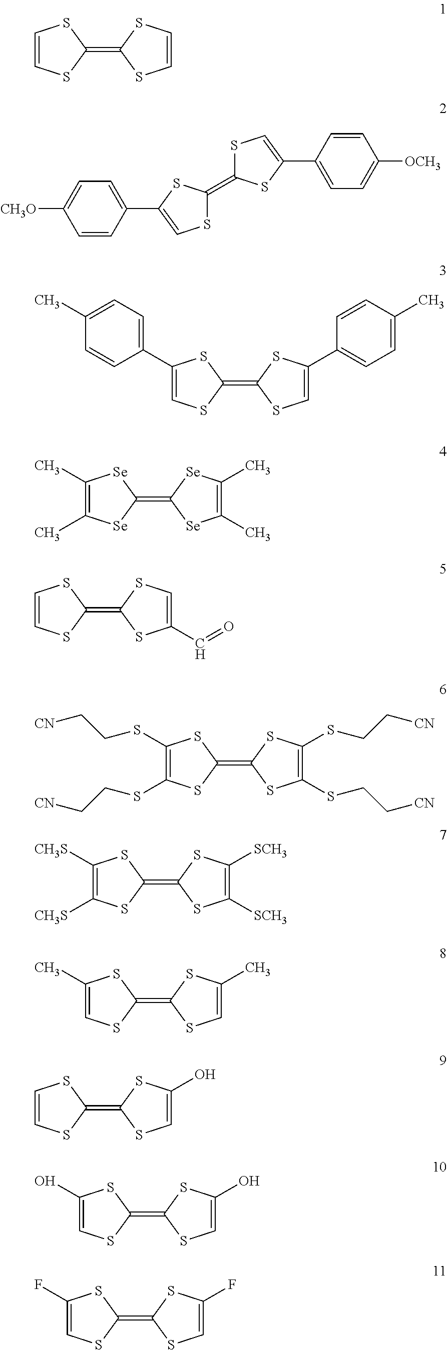

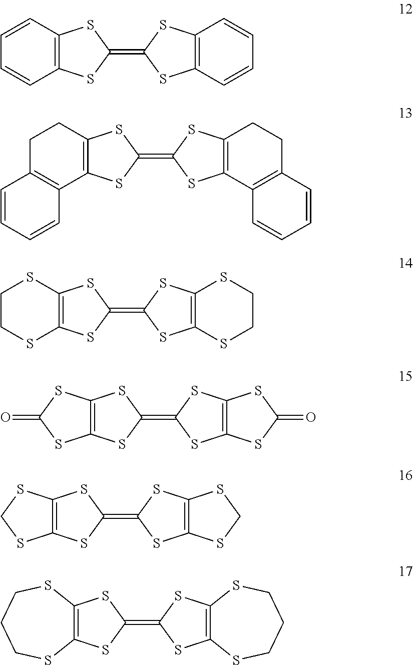

The additive composition may further include phosphate represented by Formula 10 below, in addition to the first compound and/or the second compound 1:

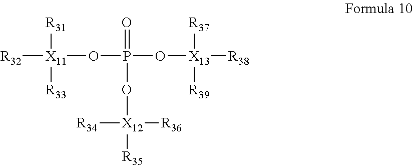

In Formula 10,

X₁₁ to X₁₃ may be each independently Si, Ge, or Sn; R₃₁ to R₃₉ may be each independently selected from a C₁-C₁₀ alkyl group, a C₂-C₁₀ alkenyl group, and a C₆-C₁₀ aryl group. The C₁-C₁₀ alkyl group and C₂-C₁₀ alkenyl group may be linear or branched.

In Formula 10, X₁₁ to X₁₃ may be Si.

In Formula 10, R₃₁ to R₃₉ may be a C₁-C₁₀ alkyl group, for example, a methyl group, an ethyl group, a propyl group, a butyl group, a pentyl group, a hexyl group, a heptyl group, or an octyl group.

In some embodiments, in the phosphate represented by Formula 10, X₁₁ to X₁₃ may be Si; and R₃₁ to R₃₉ may be a methyl group, but not limited thereto.

As used herein, with regard to the term “a substituted or unsubstituted”, “substituted” means substitution with a halogen atom, a C₁-C₁₀ alkyl group substituted with a halogen atom (for example, CF₃, CHF₂, CH₂F, CCl₃, or the like), a C₁-C₁₀ alkoxy group, a hydroxyl group (—OH), a nitro group (—NO₂), an azido group (—N₃), a cyano group (—CN), an amino group (—NRR′, wherein R and R′ are independently hydrogen or a C₁-C₁₀ alkyl group), an amido group (—C(═O)NRR′, wherein R and R′ are independently hydrogen or a C₁-C₁₀ alkyl group), an amidino group (—C(═NH)NRR′, wherein R and R′ are independently hydrogen or a C₁-C₁₀ alkyl group), a hydrazine group (—NHNRR′, wherein R and R′ are independently hydrogen or a C₁-C₁₀ alkyl group), a hydrazone group (—CR═NHNR′R″, wherein R, R′ and R″ are independently hydrogen or a C₁-C₁₀ alkyl group), a carboxyl group (—CO₂H) or a salt thereof, a sulfonyl group, a sulfamoyl group, a sulfonic acid group or a salt thereof (—SO₃H), a phosphoric acid (—P(═O)(OH)₂) or a salt thereof, or a C₁-C₁₀ alkyl group, a C₂-C₁₀ alkenyl group, a C₂-C₁₀ alkynyl group, or a C₁-C₁₀ heteroalkyl group.

An amount of the additive composition may be from about 0.005 parts to about 5 parts by weight, and in some embodiments, from about 0.05 parts to about 1 part by weight, based on 100 parts by weight of a total weight of the electrolyte. When the amount of the additive composition is within these ranges, lithium ions between the electrode and the electrolyte may easily form a thin film.

The electrolyte of a lithium secondary battery serves as a path for lithium ions. Accordingly, if the electrolyte is oxidized or reduced through reaction with an electrode active material during charging and discharging the battery, migration of lithium ions through the electrolyte may be impaired, thus deteriorating charging and discharging performances of the lithium secondary battery.

Oxidation potentials of the first compound and the second compound are lower than an oxidation potential of a nonaqueous organic solvent of the electrolyte, for example, by 3 Volts (“V”) or greater. This is attributed to two or more 5-membered rings linked by double bonds in the first compound and second compound. Accordingly, when a lithium secondary battery using the electrolyte including the first compound and/or the second compound is operated, the first compound and/or the second compound may be oxidized and/or decomposed at a higher rate than the nonaqueous organic solvent, thus resulting in a stable thin film on a surface of an electrode (for example, cathode) of the lithium secondary battery. Although the film formation mechanism has not been revealed yet, ring opening by oxidation or polymerization of the first compound and/or the second compound may lead to the formation of the thin film. The thin film formed on the surface of the cathode blocks a cathode active material from directly contacting the electrolyte, thereby preventing the electrolyte from oxidizing on the surface of the cathode, and the charging and discharging performance of the lithium secondary battery from deteriorating. The thin film formed on the surface of the cathode may allow only lithium ions to pass through, but not electrons. Thus, the lithium secondary battery that uses the electrolyte including the first compound and/or the second compound may have improved lifetime characteristics and high-rate characteristics.

The nonaqueous organic solvent, which is in the electrolyte of a lithium secondary battery according to the above embodiment, may serve as a migration medium of ions involved in electrochemical reactions of the battery. Any suitable nonaqueous organic solvent that is commonly used in the art may be used. Non-limiting examples of the nonaqueous organic solvent are a carbonate solvent, an ester solvent, an ether solvent, a ketone solvent, an alcohol solvent, an aprotic bipolar solvent, and a combination thereof.

Non-limiting examples of the carbonate solvent are dimethyl carbonate (“DMC”), diethyl carbonate (“DEC”), dipropyl carbonate (“DPC”), methylpropyl carbonate (“MPC”), ethylpropyl carbonate (“EPC”), methylethyl carbonate (“MEC”), ethylene carbonate (“EC”), propylene carbonate (“PC”), and butylene carbonate (“BC”).

Non-limiting examples of the ester solvent are methyl acetate, ethyl acetate, n-propyl acetate, isopropyl acetate, methyl propionate (“MP”), ethyl propionate, n-propyl propionate, isopropyl propionate, γ-butyrolactone, 4-decanolide, 5-decanolide, 6-valerolactone, mevalonolactone, and ∈-caprolactone.

Non-limiting examples of the ether solvent are diethyl ether, ethyl propyl ether, dipropyl ether, propyl butyl ether, dibutyl ether, tetraglyme, diglyme, 1,2-dimethoxyethane (“DME”), 1,4-dioxane, 2-methyltetrahydrofuran (“2-methyl-THF”), and tetrahydrofuran (“THF”).

Non-limiting examples of the ketone solvent is acetone, methyl ethyl ketone, methyl propyl ketone, ethyl propyl ketone, and cyclohexanone.

Non-limiting examples of the alcohol solvent are methyl alcohol, ethyl alcohol, n-propyl alcohol, and isopropyl alcohol.

Non-limiting examples of the aprotic bipolar solvent are nitriles (such as R—CN, wherein R is a C₂-C₂₀ straight linear, branched, or cyclic hydrocarbon-based moiety that may include a double-bond, aromatic ring or an ether bond), amides (such as N,N-dimethylformamide and N,N-dimethylacetamide), dimethylsulfoxide (“DMSO”), dioxolanes (such as 1,3-dioxolane), and sulfolanes.

Only one of the nonaqueous organic solvents may be used alone. Alternatively, at least two of the nonaqueous organic solvents may be used in combination. In this regard, one of ordinary skill in the art would be able to select a mixing ratio of the at least two of the nonaqueous organic solvents to achieve the desired performance of the lithium secondary battery.

For example, the carbonate solvent may be a mixture of a cyclic carbonate and a linear carbonate, which may be determined to achieve a desired dielectric constant and viscosity of the carbonate solvent. For example, a combination of a cyclic carbonate and linear carbonate in a volume ratio of about 1:1 to about 1:9 may be used.

The nonaqueous organic solvent may further include an aromatic hydrocarbon organic solvent in the carbonate solvent. The carbonate solvent and the aromatic hydrocarbon organic solvent may be mixed, for example, in a volume ratio of about 1:1 to about 30:1.

An example of the aromatic hydrocarbon organic solvent is an aromatic hydrocarbon-based compound represented by Formula 1 below:

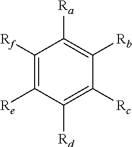

In the formula above, Rₐ to R_{f} may be each independently a hydrogen atom, a halogen atom, a C₁-C₁₀ alkyl group, a haloalkyl group, or a combination thereof.

Examples of the aromatic hydrocarbon organic solvent are benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, 3,5-difluorotoluene, 2,3,4-trifluorotoluene, 2,3,5-trifluorotoluene, 2,3,6-trifluorotoluene, 3,4,5-trifluorotoluene, 2,4,5-trifluorotoluene, 2,4,6-trifluorotoluene, 2-chlorotoluene, 3-chlorotoluene, 4-chlorotoluene, 2,3-dichlorotoluene, 2,4-dichlorotoluene, 2,5-dichlorotoluene, 2,6-dichlorotoluene, 2,3,4-trichlorotoluene, 2,3,5-trichlorotoluene, 2,3,6-trichlorotoluene, 3,4,5-trichlorotoluene, 2,4,5-trichlorotoluene, 2,4,6-trichlorotoluene, 2-iodotoluene, 3-iodotoluene, 4-iodotoluene, 2,3-diiodotoluene, 2,4-diiodotoluene, 2,5-diiodotoluene, 2,6-diiodotoluene, 3,4-diiodotoluene, 3,5-diiodotoluene, 2,3,4-triiodotoluene, 2,3,5-triiodotoluene, 2,3,6-triiodotoluene, 3,4,5-triiodotoluene, 2,4,5-triiodotoluene, 2,4,6-triiodotoluene, o-xylene, m-xylene, p-xylene, and combinations thereof.

The lithium salt, which is in the electrolyte of a lithium secondary battery according to the above embodiment, may be soluble in the organic solvent, and serves as a lithium ion source in the lithium secondary battery to enable routine operation of the lithium secondary battery. The lithium salt may be any suitable lithium salt that is commonly used for lithium batteries. Examples of the lithium salt for the nonaqueous electrolyte are LiPF₆, LiBF₄, LiSbF₆, LiAsF₆, LiCF₃SO₃, Li(CF₃SO₂)₃C, Li(CF₃SO₂)₂N, LiC₄F₉SO₃, LiClO₄, LiAlO₄, LiAlCl₄, LiBPh₄, LiN(CₓF₂ₓ₊₁SO₂)(CₓF_{2y+1}SO₂) (where x and y are natural numbers), LiCl, LiI, LIBOB (lithium bisoxalato borate), and combination thereof. These lithium salts may be used as a supporting electrolytic salt.

A concentration of the lithium salt may be within a range known to one of ordinary skill in the art. The concentration of the lithium salt is not specifically limited, and in some embodiments, may be in a range of about 0.1 M to about 2.0 M in the electrolyte. When the concentration of the lithium salt is within this range, a concentration of the electrolyte may be appropriately maintained to have improved performance, and a viscosity of the electrolyte may be appropriately maintained to improve mobility of lithium ions.

Hereinafter, embodiments of a lithium secondary battery including the electrolytes described above will be described in detail.

According to an exemplary embodiment, a lithium secondary battery includes a cathode, an anode, and an electrolyte, wherein the electrolyte includes a lithium salt, a nonaqueous organic solvent, and an additive composition, the additive composition including at least one of a first compound represented by Formula 1 above and a second compound represented by Formula 2 below. Descriptions of Formula 1, Formula 2, the nonaqueous organic solvent, and the lithium salt, which are provided above, will not be repeated here.

A thin film may be disposed between the cathode and the electrolyte. The thin film is not a film formed via an additional process, such as coating. The thin film may be a film derived from at least a part of the additive composition in the electrolyte.

In the electrolyte of the lithium secondary battery, since the first compound and/or the second compound form the thin film on the surface of the cathode, the amounts of the first compound and the second compound may be reduced after operation of the lithium secondary battery.

For example, the amounts of the first compound and/or second compound in the electrolyte after operation of the lithium secondary battery may be smaller than those before the operation of the lithium secondary battery.

According to the above-embodiments of the inventive concept, the lithium secondary battery may have a thin film formed on the surface of the cathode due to oxidation of at least a part of the additive composition in the electrolyte during initial charging of the lithium secondary battery. Thus, the lithium secondary battery may have improved capacity retention characteristics, lifetime characteristics and high-rate characteristics even when charged at a high voltage above 4.3 V.

The thin film formed on the surface of the cathode may have a thickness of about 0.05 nanometers (“nm”) to about 100 nm, in some embodiments, may have a thickness of about 0.1 nm to about 80 nm, and in some other embodiments, may have a thickness of about 0.5 nm to about 50 nm. When the thickness of the thin film is within these ranges, the thin film may not adversely affect transfer of lithium ions and may effectively prevent oxidation of the electrolyte on the surface of the cathode.

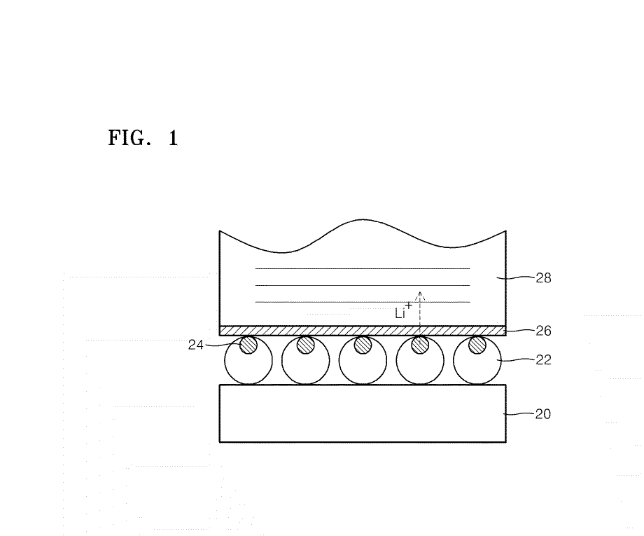

FIG. 1 is a schematic cross-sectional view illustrating a thin film formed on a surface of a cathode of a lithium secondary battery, according to an exemplary embodiment. Referring to FIG. 1, a durable thin film 26 is formed on surfaces of cathode active material 22 applied on a cathode current collector 20. As illustrated in FIG. 1, lithium ions 24 may effectively migrate from the cathode to the electrolyte 28.

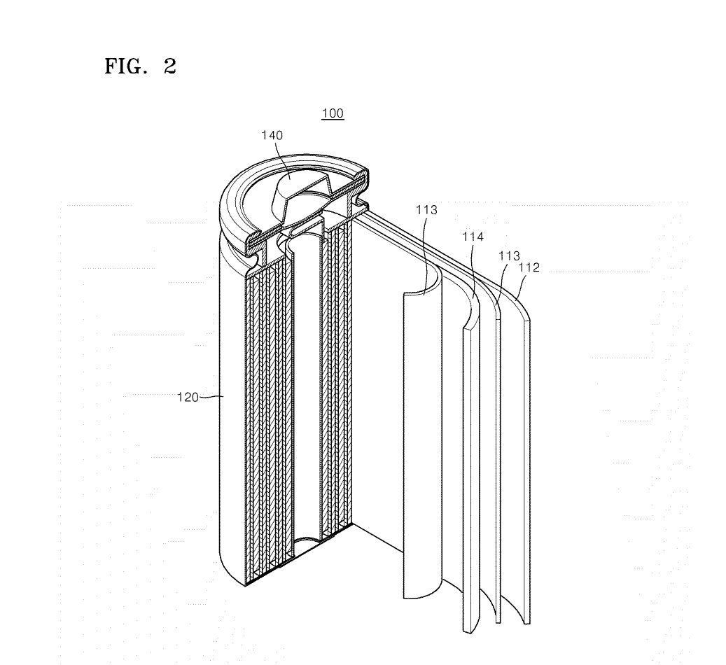

FIG. 2 is an exploded perspective view of a lithium secondary battery 100 according to an embodiment. Although the lithium secondary battery 100 illustrated in FIG. 2 is cylindrical, it is not limited thereto, and lithium secondary batteries according to embodiments may be of a rectangular type or a pouch type.

Lithium secondary batteries may be classified as lithium ion batteries, lithium ion polymer batteries, or lithium polymer batteries, according to the type of separator and/or electrolyte included therein. In addition, lithium batteries may be classified as cylindrical type, rectangular type, coin type, or pouch type, according to the shape thereof. Lithium batteries may also be classified as either bulk type or thin film type, according to the size thereof. Lithium secondary batteries according to embodiments may have any of appropriate shapes. The structure of a lithium secondary battery and a method of manufacturing the same are known in the art, so a detailed description thereof will not be recited here.

Referring to FIG. 2, the lithium secondary battery 100, which is cylindrical, includes an anode 112, a cathode 114, a separator 113 disposed between the anode 112 and the cathode 114, and an electrolyte (not shown) impregnated into the anode 112, the cathode 114, and the separator 113, a battery case 120, and a sealing member 140 sealing the battery case 120. The lithium secondary battery 100 is manufactured by sequentially stacking the anode 112, the cathode 114, and the separator 113 upon one another to form a stack, rolling the stack in a spiral form, and accommodating the rolled up stack in the battery case 120.

The anode 112 includes a current collector and an anode active material layer disposed on the current collector. The anode active material layer includes an anode active material.

The current collector may be any one selected from a copper foil, a nickel foil, a stainless steel foil, a titanium foil, a nickel foam, a copper foam, a polymeric substrate coated with a conductive metal, and a combination thereof.

The anode active material is not specifically limited, and any anode active material commonly used in the art may be used. Examples of the anode active material include lithium metal, a metal that is alloyable with lithium, a transition metal oxide, a material that allows doping or undoping of lithium, a material that allows reversible intercalation and deintercalation of lithium ions, and the like.

Non-limiting examples of the transition metal oxide are vanadium oxide and lithium vanadium oxide. Non-limiting examples of the material that allows doping or undoping of lithium are silicon (Si), SiOₓ wherein 0<x<2, an Si—Y alloy wherein Y is an alkali metal, an alkali earth metal, a Group XIII element, a Group XIV element, a transition metal, a rare earth element, or combinations thereof (except for Si), Sn, SnO₂, an Sn—Y alloy wherein Y is an alkali metal, an alkali earth metal, a Group XIII element, a Group XIV element, a transition metal, a rare earth element, or a combination thereof (except for Sn), and combinations of at least one of these materials and SiO₂. Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or combinations thereof.

The material that allows reversible intercalation and deintercalation of lithium ions may be any carbonaceous anode active material that is commonly used in a lithium ion secondary battery. Non-limiting examples of this material are crystalline carbon, amorphous carbon, and combinations thereof. Non-limiting examples of the crystalline carbon are graphite, such as natural graphite or artificial graphite that are in amorphous, plate, flake, spherical or fibrous form. Non-limiting examples of the amorphous carbon are soft carbon (carbon sintered at low temperatures), hard carbon, meso-phase pitch carbides, and sintered corks.

The anode active material layer may include a binder, and optionally, a conducting agent.

The binder strongly binds anode active material particles together and to a current collector. Examples of the binder are, but not limited to, polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (“SBR”), acrylated SBR, epoxy resin, and nylon.

The conducting agent is used to provide conductivity to electrodes. Any electron conducting material that does not induce chemical change in batteries may be used. Non-limiting examples of the conducting agent are natural graphite, artificial graphite, carbon black, acetylene black, ketjen black, carbon fibers, metal powder or metal fiber of copper (Cu), nickel (Ni), aluminum (Al), silver (Ag), and the like, conductive materials, such as a polyphenylene derivative, and combinations thereof.

The cathode 114 includes a current collector and a cathode active material layer disposed on the current collector.

The current collector may be an Al current collector, but is not limited thereto.

The cathode active material is not specifically limited, and may be any cathode active material commonly used in the art. For example, a compound that allows reversible intercalation and deintercalation of lithium. The cathode active material may include at least one composite oxide of lithium and a metal selected from cobalt (Co), manganese (Mn), nickel (Ni), iron (Fe), and a combination thereof. Non-limiting examples of the cathode active material are LiCoO₂, LiNi_{1-X}Co_{X}O₂ (0≦x<1), L_{1-X}M_{X}O₂ (M is Mn or Fe, 0.03<x<0.1), Li[Ni_{X}Co_{1-2X}Mn_{X}]O₂(0<x<0.5), Li[Ni_{X}Mn_{X}]O₂ (0<x≦5), Li₁₊ₓ(Ni,Co,Mn)_{1-y}O_{z}(0<x≦1, 0≦y<1, and 2≦z≦4), LiM₂O₄ (M is Ti, V, or Mn), LiM_{X}Mn_{2-X}O₄(M is a transition metal, and 0<x<1), LiFePO₄ and LiMPO₄ (M is Mn, Co, or Ni). Alternatively, the cathode material may include a vanadium oxide and/or derivatives thereof, including V₂O₅, V₂O₃, VO₂(B), V₆O₁₃, V₄O₉, V₃O₇, Ag₂V₄O₁₁, AgVO₃, LiV₃O₅, δ-Mn_{y}V₂O₅, δ-NH₄V₄O₁₀, Mn_{0.8}V₇O₁₆, LiV₃O₈, CuₓV₂O₅, and CrₓV₆O₁₃, M₂(XO₄)₃ (M is a transition metal, and X is S, P, As, Mo, or W), and Li₃M₂(PO₄)₃ (M is Fe, V, or Ti), Alternatively, the cathode material may include Li₂MSiO₄ (M is Fe or Mn).

In some embodiments, the cathode active material may be LiMn₂O₄, LiNi₂O₄, LiCoO₂, LiNiO₂, LiMnO₂, Li₂MnO₃, LiFePO₄, L₁₊ₓ(Ni,Co,Mn)₁₋ₓO₂(0.05≦x≦0.2), or LiNi_{0.5}Mn_{1.5}O₄.

The compounds listed above as cathode active materials may have a surface coating layer (hereinafter, “coating layer”). In another embodiment, a mixture of a compound without coating layer and a compound having a coating layer, the compounds being selected from the compounds listed above, may be used. The coating layer may include at least one compound of a coating element selected from oxide, hydroxide, oxyhydroxide, oxycarbonate, and hydroxycarbonate of the coating element. The compounds for the coating layer may be amorphous or crystalline. The coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or mixtures thereof. The coating layer may be formed using any method that does not adversely affect the physical properties of the cathode active material when a compound of the coating element is used. For example, the coating layer may be formed using a spray coating method, a dipping method, or any other method known to one of ordinary skill in the art. Thus, a detailed description thereof will be omitted herein.

The cathode active material layer may include a binder and a conducting agent.

An operating voltage of the cathode active material may be from about 4.0 V to about 5.5 V. Examples of the cathode active material having an operating voltage in this range are an OLO material and a material having a 5 V spinel structure.

The binder strongly binds positive cathode active material particles together and to a current collector. Examples of the binder include, but not limited to, polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber (“SBR”), acrylated SBR, epoxy resin, and nylon.

The conducting agent is used to provide conductivity to electrodes. Any electron conducting material that does not induce chemical change in batteries may be used. Examples of the conducting agent include natural graphite, artificial graphite, carbon black, acetylene black, ketjen black, denka black, carbon fibers, and metallic materials, including copper, nickel, aluminum, and silver, in powder or fiber form. The conducting agent may include a single conductive material, such as a polyphenylene derivative, or a combination of at least two conductive materials.

The amounts of the cathode active material, the binder, and the conducting agent may be equivalent to those commonly used in lithium batteries. For example, a weight ratio of the cathode active material to a mixture of the conducting agent and the binder may be from about 98:2 to about 92:8, and in some embodiments from about 95:5 to about 90:10. A mixing ratio of the conducting agent to the binder may be, but not limited, from about 1:1.5 to about 1:3.

The anode 112 and the cathode 114 may be each manufactured by mixing an active material, a conducting agent, and a binder in a solvent to prepare an active material composition, and coating the active material composition on a current collector. Any method of manufacturing such electrodes which is known to one of ordinary skill in the art may be used. Thus, a detailed description thereof will not be provided herein. N-methylpyrrolidone (“NMP”) may be used as the solvent, but the present embodiments are not limited thereto.

A separator may be disposed between the cathode and the anode, according to the type of the lithium battery. The separator may include polyethylene, polypropylene, polyvinylidene fluoride (“PVDF”), or a multi-layer of at least two thereof. Examples of the separator include mixed multi-layer separators, including a polyethylene/polypropylene double-layer separator, polyethylene/polypropylene/polyethylene triple-layer separator, and a polypropylene/polyethylene/polypropylene triple-layer separator.

One or more embodiments will now be described in detail with reference to the following examples. However, these examples are not intended to limit the scope of the one or more embodiments.

Technical descriptions that are known to one of ordinary skill in the art will be omitted herein.

### EXAMPLES

### Comparative Example A

An electrolyte A having the composition of Table 1 was prepared.

L₁₊ₓ(Ni,Co,Mn)₁₋ₓO₂ (0.05≦x≦0.25) powder as a cathode active material, 5 percent by weight (“wt %”) of polyvinylidene fluoride (“PVdF”) binder dissolved in N-methylpyrrolidone (“NMP”), and a conducting agent (Denka black) were mixed in a weight ratio of 90:5:5 to prepare a cathode forming slurry. The cathode forming slurry was coated on an aluminum foil having a thickness of 15 μm. The aluminum foil coated with the cathode forming slurry was dried in a 90° C. oven for about 2 hours (first drying), and then in a 120° C. vacuum oven for about 2 hours (second drying) until the NMP was completely evaporated, followed by rolling and punching to obtain a cathode having a diameter of about 1.5 centimeter (“cm”) and a thickness of about 50-60 μm for use in a coin cell. The cathode had a capacity of about 1.9 milliAmpere×hour per square centimeter (“mA×h/cm²”).

The cathode, a graphite anode (ICG10H, available from Mitsubishi), a polyethylene separator (Celgard 3501, available from Celgard), and the electrolyte A prepared as described above were used to manufacture a 2032 standard coin cell.

### Comparative Example B

A battery was manufactured in the same manner as in Comparative Example A, except that an electrolyte B with the composition as in Table 1, instead of the electrolyte A, was used.

### Comparative Example C

A battery was manufactured in the same manner as in Comparative Example A, except that an electrolyte C with the composition as in Table 1, instead of the electrolyte A, was used.

### Example 1

A battery was manufactured in the same manner as in Comparative Example A, except that an electrolyte 1 with the composition as in Table 1, instead of the electrolyte A, was used.

### Example 2

A battery was manufactured in the same manner as in Comparative Example A, except that an electrolyte 2 with the composition as in Table 1, instead of the electrolyte A, was used.

### Example 3

A battery was manufactured in the same manner as in Comparative Example A, except that an electrolyte 3 with the composition as in Table 1, instead of the electrolyte A, was used.

TABLE 1

| | Nonaqueous | | |
|---|---|---|---|
| | organic solvent³ | Lithium salt | Additive⁴ |
| Electrolyte A | FEC¹ and DMC² | 1.3M LiPF₆ | — |
| Electrolyte B | FEC and DMC | 1.3M LiPF₆ | 2 wt % TMSPa⁵ |
| Electrolyte C | FEC and DMC | 1.3M LiPF₆ | 0.1 wt % vinylene |
| | | | trithiocarbonate |
| | | | (vinylenetrithiocarbonate) |
| Electrolyte 1 | FEC and DMC | 1.3M LiPF₆ | 2 wt % TMSPa |
| | | | 0.1 wt % Compound 1⁶ |
| Electrolyte 2 | FEC and DMC | 1.3M LiPF₆ | 2 wt % TMSPa |
| | | | 0.1 wt % Compound 15⁷ |
| Electrolyte 3 | FEC and DMC | 1.3M LiPF₆ | 2 wt % TMSPa |
| | | | 0.1 wt % Compound 17⁸ |

¹FEC = fluoroethylene carbonate
²DMC = dimethyl carbonate
³FEC:DMC = 1:3 by volume
⁴The amount of the additive is based on 100 wt % of a sum of the amounts of the nonaqueous organic solvent and the lithium salt.
⁵TMSPa = tris(trimethylsilyl)phosphate

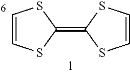

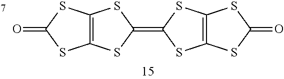 [SMILES: O=c1sc2c(s1)SC(=C1Sc3sc(=O)sc3S1)S2]

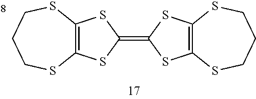 [SMILES: C1CSC2=C(SC1)SC(=C1SC3=C(SCCCS3)S1)S2]

### Evaluation Example 1

### Measurement of Oxidation Potential of Additive

Oxidation potentials of TMSPa, vinylene trithiocarbonate, and Compounds 1, 15, and 17 used as additives in Comparative Examples B and C and Examples 1 to 3, respectively, were calculated using density functional theory (DFT; B3LYP/6-311+G(d,p))-based ab-initio calculation (Gaussian 03). The results are shown in Table 2 below. In calculating the oxidation potentials, oxidation reaction as illustrated below is was considered.

M(solution)→M⁺(solution)+e⁻(gas)

In this oxidation reaction, M and e⁻ indicate molecules and electrons of the additive in the additive composition, respectively.

A polarized continuum model (“PCM”) was used in consideration of effects of neighboring electrolyte environment around additive molecules on the oxidation potential of the additive in the additive composition.

TABLE 2

| | | Vinylene | Com- | Com- | Com- |
|---|---|---|---|---|---|
| | TMSPa | trithiocarbonate | pound 1 | pound 15 | pound 17 |
| Oxidation | 5.86 | 4.34 | 2.9 | 3.23 | 3.01 |
| potential | | | | | |
| (eV) | | | | | |
| (vs. Li/Li⁺) | | | | | |

Referring to Table 2 above, the Compounds 1, 15, and 17 were found to have an oxidation potential lower by about 3 V or greater than a common carbonate-based nonaqueous organic solvent, which is known to have an oxidation potential of from about 6.5 V to about 6.7 V. This indicates that a lithium secondary battery using an electrolyte containing the Compound 1, 15, or 17 is likely to be decomposed earlier than the nonaqueous organic solvent of the electrolyte, and effectively form a thin film on a surface of the cathode.

### Evaluation Example 2

### Evaluation of Lifetime Characteristics

### Formation Charge and Discharge

Formation charging/discharging was performed twice on the batteries of Comparative Examples A to C and Examples 1 to 3 at room temperature.

In a first formation process constant-current charging was performed on each battery at 0.1 Coulomb (“C”) to a voltage of 4.65 V, followed by constant-voltage charging to a 0.05 C current. Next, constant-current discharging was performed at 0.1 C to a voltage of 2.5 V. A second formation process was performed in the same manner as in the first formation process.

The term “1 C charging” refers to charging for 1 hour to reach the capacity of a battery in milliAmpere per hour (“mA×h”). Likewise, the term “1 C discharging” refers to discharging for 1 hour to fully discharge the capacity of the battery in mA×h.

### Standard Charge and Discharge

After the formation charging and discharging, each of the batteries obtained in Comparative Examples A to C and Examples 1 to 3 was charged at 0.5 C to a voltage of 4.55 V, and then discharged at 0.2 C to a voltage of 2.5 V. These charging and discharging conditions were termed as “standard charging and discharging conditions,” and the discharge capacity in these conditions was defined as a “standard capacity.” The measured standard capacities ranged from about 3.2 mA×h to about 3.5 mA×h.

### Capacity Retention Rate (%)

Charging was performed on each of the batteries of Comparative Examples A to C and Examples 1 to 3 in a 45° C. constant-temperature chamber at 1 C to a voltage of 4.55 V, followed by discharging at 1 C to a voltage of 2.8 V. Then, a discharge capacity (discharge capacity after the 1st cycle) was measured. While the cycle of 1 C charging and 1 C discharging was repeated in the 45° C. chamber, a discharge capacity after each cycle was measured. The charging and discharging cycle was repeated 300 times in total. A capacity retention rate was calculated using the discharge capacity from each of the cycles. The cycle retention was calculated using Equation 1 below.

Capacity retention rate [%]=100*(n^{th} cycle discharge capacity/1^{st} cycle discharge capacity) Equation 1

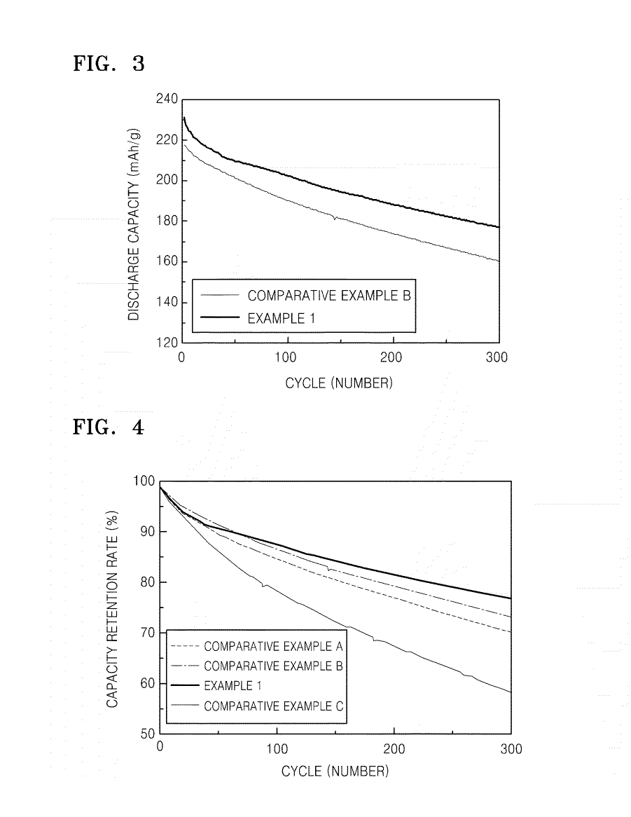

FIG. 3 is a graph of discharge capacities of the batteries of Example 1 and Comparative Example B. FIG. 4 is a graph of capacity retention rates of the batteries of Example 1 and Comparative Examples A, B, and C, obtained using Equation 1 above. Table 3 show capacity retention rates after 300^{th} cycle of the batteries of Example 1 and Comparative Examples A, B, and C.

TABLE 3

| Example | Capacity retention rate after 300^{th} cycle (%) |
|---|---|
| Comparative Example A | 70.4 |
| Comparative Example B | 73.5 |
| Comparative Example C | 58.3 |
| Example 1 | 77.3 |

Referring to FIGS. 3 and 4 and Table 3 above, the battery of Example 1 using Electrolyte 1 were found to have better lifetime characteristics, as compared with the batteries of Comparative Examples A, B and C using Electrolytes A, B, and C, respectively.

### Evaluation Example 4

### Evaluation of High-Rate Characteristics

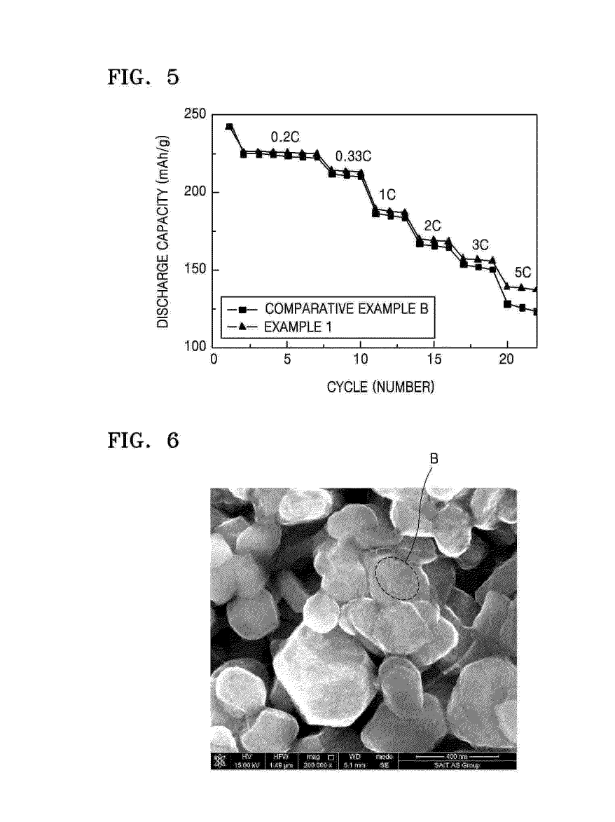

High-rate discharge characteristics (rate capacities) of the batteries of Comparative Examples A and B and Examples 1 to 3 were evaluated after charging each cell at a constant current of 0.1 C and a constant voltage of 1.0 V (0.01 C cut-off), a rest for about 10 minutes, and then discharging the batteries at a constant current of 0.2 C, 0.33 C, 1 C, 2 C and 5 C, respectively, with a cut-off voltage of 2.5 V. The results are shown in FIG. 5 and Table 4.

TABLE 4

| | | | 5 C Discharge |
|---|---|---|---|
| | 0.2 C Discharge | 5 C Discharge | capacity/0.2 |
| | capacity | capacity | Discharge capacity × |
| Example | (mA × h/g) | (mA × h/g) | 100 (%) |
| Comparative | 229.0 | 135.8 | 59.3 |
| Example A | | | |
| Comparative | 229.7 | 132.1 | 57.5 |
| Example B | | | |
| Example 1 | 232.2 | 139.1 | 59.9 |
| Example 3 | 228.9 | 138.4 | 60.5 |

Referring to FIG. 5 and Table 4, the batteries of Examples 1 and 3 were found to have better high-rate characteristics, as compared with the batteries of Comparative Examples A and B.

### Evaluation Example 5

### Confirmation of Film Formation

After completion of the lifetime characteristics evaluation in Evaluation Example 1, the battery of Example 1 was disassembled in a glove box to recover the cathode, which was then cleaned with dimethyl carbonate to remove the electrolyte and the lithium salt therefrom, and dried. Afterward, a surface of the cathode was observed by electron scanning microscopy (“SEM”). The results are shown in FIG. 6.

Referring to FIG. 6, a thin film (for example, denoted by “B”) was identified to be on the surface of the cathode active material.

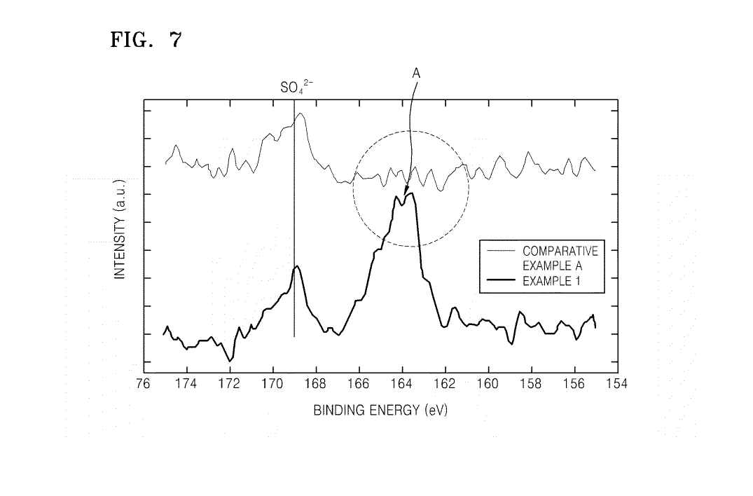

After completion of the lifetime characteristics evaluation in Evaluation Example 1, the batteries of Example 1 and Comparative Example A were each disassembled in a glove box to recover the cathode, which was then cleaned with dimethyl carbonate to remove the electrolyte and the lithium salt therefrom, and dried. A surface material was taken from the cathode as a sample, which was then analyzed using an X-ray photoelectron spectroscope (“XPS”) (Sigma Probe, Thermo, UK). The results are shown in FIG. 7.

Referring to FIG. 7, a peak A (in a binding energy range of about 162 eV to about 167 eV) appeared in S 2p XPS spectra of the cathode surface material sample of the battery of Example 1, but not in S 2p XPS spectra of the cathode surface material sample of the battery of Comparative Example A. The peak A indicates the presence of a ring structure including S, like thiophene.

Based on the results of FIGS. 6 and 7, the battery of Example 1 was found to have a thin film derived from Electrolyte 1 on the surface of the cathode, wherein the thin film remains, not decomposed, even after operation at high-temperatures.

According to the one or more embodiments of the inventive concept, a thin film may be formed on a surface of the cathode active material of the battery during initial charging and discharging, from an additive in the electrolyte, and thus prevents direct contact of the electrolyte with the cathode active material. The thin film allows only lithium ions to pass through, but not electrons, so that oxidation of the electrolyte from losing electrons to the cathode in a high-temperature, high-voltage condition may be prevented. The additive may be decomposed in high-temperature, high-voltage conditions to form the thin film, which prevents decomposition of the electrolyte. The prevention of the electrolyte loss in high-temperature and high-voltage conditions may secure the lithium secondary battery to retain high capacity and efficiency, and thus to have longer lifetime.

The improvements in lifetime characteristics and high-temperature storage characteristics enable the lithium secondary batteries according to the above-described embodiments to normally operate in extreme environments when used in electric vehicles or in power storages that are liable to expose to high-temperatures. According to the embodiments, the electrolyte is also expected to be used in a lithium secondary battery using a cathode active material to which a far high voltage is applied, for example, a 5 V spinel, or a high-voltage phosphate cathode active material, taking an important part in improving the energy density of batteries for electric vehicles and power storages.

As described above, according to the one or more of the above embodiments, since the electrolyte includes the first compound of Formula 1 above and/or the second compound of Formula 2 above as an additive(s), the first compound and/or the second compound may form a thin film on a surface of the anode of a lithium secondary battery including the electrolyte, thereby preventing oxidation and decomposition of the electrolyte during operation of the lithium secondary battery, and improving lifetime characteristics and high-rate characteristics of the lithium secondary battery.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An electrolyte for a lithium secondary battery, the electrolyte comprising:
a lithium salt;
a nonaqueous organic solvent; and
an additive composition,
wherein the additive composition comprises at least one of a first compound of Formula 1 and a second compound of Formula 2: 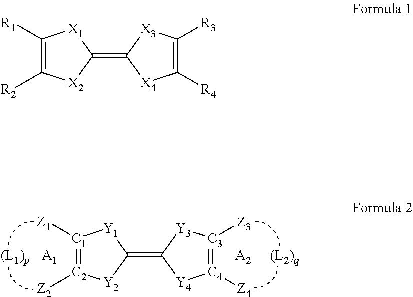
wherein, in Formulae 1 and 2,
X₁ to X₄, and Y₁ to Y₄ are each independently selected from oxygen, sulfur, selenium, or tellurium;
A₁ and A₂ each indicates a ring;
Z₁ to Z₄ are each independently selected from, —O—, —S—, —Se—, —Te—, —C(═O)—, —C(R₁₁)(R₁₂)—, —C(R₁₃)═, and —N(R₁₄)—;
L₁ and L₂ are each independently selected from ═C(R₂₁)—C(R₂₂)═, —C(R₂₃)(R₂₄)—, —C(R₂₅)═C(R₂₆)—, —C(R₂₇)═, and —C(═O)—;
p and q are each independently an integer from 1 to 5,
wherein,
when p is 2 or greater, groups L₁ are each identical to or different from each other, and
when q is 2 or greater, groups L₂ are each identical to or different from each other;
R₁ to R₄, R₁₁ to R₁₄, and R₂₁ to R₂₇ are each independently selected from a hydrogen atom, a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a substituted or unsubstituted C₁-C₆₀ alkyl group, a substituted or unsubstituted C₁-C₆₀ alkoxy group, a substituted or unsubstituted C₁-C₆₀ heteroalkyl group, a substituted or unsubstituted C₂-C₆₀ alkenyl group, a substituted or unsubstituted C₂-C₆₀ alkynyl group, a substituted or unsubstituted C₃-C₁₀ cycloalkyl group, a substituted or unsubstituted C₃-C₁₀ heterocycloalkyl group, a substituted or unsubstituted C₂-C₁₀ cycloalkenyl group, a substituted or unsubstituted C₂-C₁₀ heterocycloalkenyl group, a substituted or unsubstituted C₆-C₆₀ aryl group, a substituted or unsubstituted C₆-C₆₀ aryloxy group, a substituted or unsubstituted C₂-C₆₀ heteroaryl group, -(Q₁)ᵣ-(Q₂)ₛ, —N(Q₃)(Q₄)(Q₅), —P(═O)(Q₆)(Q₇), and —P(Q₈)(Q₉)(Q₁₀)(Q₁₁);
optionally wherein at least one of R₁₁ to R₁₄ and at least one of R₂₁ to R₂₇ are linked to each other to form a substituted or unsubstituted, saturated or unsaturated ring;
Q₁ is at least one selected from —O—, —S—, —C(═O)—, a substituted or unsubstituted C₁-C₆₀ alkylene group, a substituted or unsubstituted C₂-C₆₀ alkenylene group, a substituted or unsubstituted C₃-C₁₀ cycloalkylene group, a substituted or unsubstituted C₃-C₁₀ heterocycloalkylene group, a substituted or unsubstituted C₂-C₁₀ cycloalkenylene group, a substituted or unsubstituted C₂-C₁₀ heterocycloalkenylene group, a substituted or unsubstituted C₆-C₆₀ arylene group, and a substituted or unsubstituted C₂-C₆₀ heteroarylene group;
Q₂ to Q₁₁ are each independently selected from a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, a substituted or unsubstituted C₁-C₆₀ alkyl group, a substituted or unsubstituted C₁-C₆₀ alkoxy group, a substituted or unsubstituted C₁-C₆₀ heteroalkyl group, a substituted or unsubstituted C₂-C₆₀ alkenyl group, a substituted or unsubstituted C₂-C₆₀ alkynyl group, a substituted or unsubstituted C₃-C₁₀ cycloalkyl group, a substituted or unsubstituted C₃-C₁₀ heterocycloalkyl group, a substituted or unsubstituted C₂-C₁₀ cycloalkenyl group, a substituted or unsubstituted C₂-C₁₀ heterocycloalkenyl group, a substituted or unsubstituted C₆-C₆₀ aryl group, a substituted or unsubstituted C₆-C₆₀ aryloxy group, and a substituted or unsubstituted C₂-C₆₀ heteroaryl group;
r and s are each independently an integer from 1 to 5, wherein,
when r is 2 or greater, groups Q₁ are each identical to or different from each other, and
when s is 2 or greater, groups Q₂ are each identical to or different from each other; and
C₁, O₂, O₃, and C₄ indicate positions of carbon atoms.

2. The electrolyte of claim 1, wherein the additive composition comprises the first compound of Formula 1,
wherein, in Formula 1,
X₁ to X₄ are each independently S or Se;
R₁ to R₄ are each independently selected from a hydrogen atom, a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, a n-decyl group, an isodecyl group, a sec-decyl group, a tert-decyl group, and -(Q₁)ᵣ-(Q₂)ₛ;
Q₁ is selected from —O—, —S—, —C(═O)—, a C₁-C₁₀ alkylene group, a C₆-C₁₄ arylene group, and a C₂-C₁₄ heteroarylene group;
Q₂ is selected from a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-a butyl group, a tert-butyl group, a n-pentyl group, an isopentyl group, a sec-pentyl group, a tert-pentyl group, a n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and a C₁-C₁₀ alkoxy group.

3. The electrolyte of claim 2, wherein
R₁ to R₄ are each independently selected from a hydrogen atom, a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and groups represented by Formulae 3A and 3B: 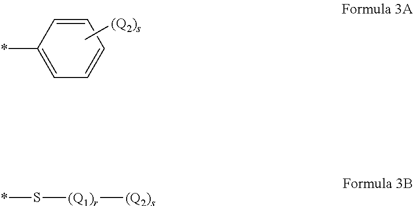
wherein, in Formulae 3A and 3B,
Q₁ is a C₁-C₁₀ alkylene group;
Q₂ is selected from a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and a C₁-C₁₀ alkoxy group; and
r and s are each independently an integer of 1, 2, or 3.

4. The electrolyte of claim 1, wherein the additive composition comprises the first compound of Formula 1,
wherein, in Formula 1,
R₁ is not a hydrogen atom, and R₂, R₃, and R₄ are all hydrogen atoms; or
R₁ and R₃ are all not hydrogen atoms, and R₂ and R₄ are hydrogen atoms; or
R₁ and R₄ are all not hydrogen atoms, and R₂ and R₃ are hydrogen atoms; or
R₁ to R₄ are all not hydrogen atoms.

5. The electrolyte of claim 1, wherein the additive composition comprises the second compound of Formula 2, wherein, in Formula 2,
Y₁ to Y₄ are each independently S or Se;
Z₁ to Z₄ are each independently selected from —S—, —C(R₁₁)(R₁₂)—, and —C(R₁₃)═; and
R₁₁ to R₁₃ are each independently selected from a hydrogen atom, a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and a C₂-C₁₀ alkenyl group.

6. The electrolyte of claim 1, wherein the additive composition comprises the second compound of Formula 2, wherein, in Formula 2,
-(L₁)ₚ- and -(L₂)_{q}- are each independently selected from the groups represented by Formulae 4A to 4F: 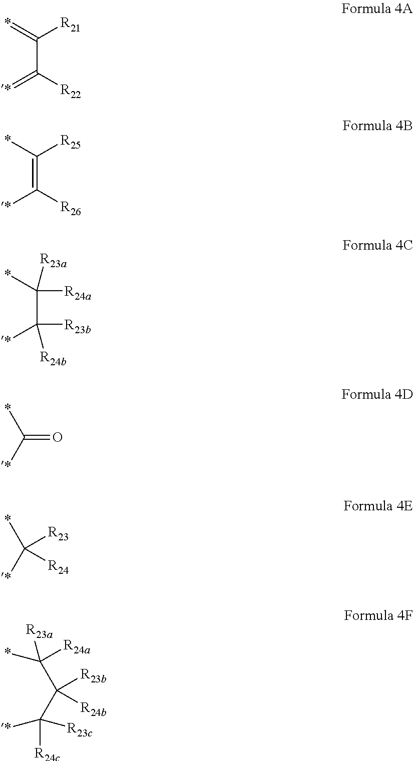
wherein, in Formulae 4A to 4F,
* indicates a binding site with Z₁ or Z₃;
*′ indicates a binding site with Z₂ or Z₄;
R₂₁, R₂₂, R₂₃, R₂₄, R₂₃ₐ, R_{23b}, R_{23c}, R₂₄ₐ, R_{24b}, R_{24c}, R₂₅, and R₂₆ are each independently selected from, a hydrogen atom, a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, a C₂-C₁₀ alkenyl group, and -(Q₁)ᵣ(Q₂)ₛ;
wherein
Q₁ is selected from —O—, —S—, —C(═O)—, a C₁-C₁₀ alkylene group, a C₆-C₁₄ arylene group, and a C₂-C₁₄ heteroarylene group;
Q₂ is selected from a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, a n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, a n-decyl group, an isodecyl group, a sec-decyl group, a tert-decyl group, and a C₁-C₁₀ alkoxy group.

7. The electrolyte of claim 1, wherein the additive composition comprises the second compound of Formula 2, wherein, in Formula 2,
at least one of Z₁ to Z₄ is selected from —C(R₁₁)(R₁₂)—, —C(R₁₃)═, and —N(R₁₄)—;
at least one of L₁ and L₂ is selected from ═C(R₂₁)—C(R₂₂)═, —C(R₂₃)(R₂₄)—, and —C(R₂₅)═C(R₂₆)—; and —C(R₂₇)═; and
optionally, at least one of R₁₁ to R₁₄ and at least one of R₂₁ to R₂₇ are linked together to form a saturated or unsaturated ring.

8. The electrolyte of claim 7, wherein the saturated or unsaturated ring is selected from a benzene ring, a naphthalene ring, and an anthracene ring; and a benzene ring, a naphthalene ring, and an anthracene ring that are substituted with at least one of a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, a C₂-C₁₀ alkenyl group, and -(Q₁)ᵣ-(Q₂)ₛ,
wherein
Q₁ is selected from —O—, —S—, —C(═O)—, a C₁-C₁₀ alkylene group, a C₆-C₁₄ arylene group, and a C₂-C₁₄ heteroarylene group; and
Q₂ is selected from a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and a C₁-C₁₀ alkoxy group; and
r and s are each independently an integer from 1 to 5.

9. The electrolyte of claim 7, wherein the A₁ ring is represented by Formula 5A, and the A₂ ring is represented by Formula 5B: 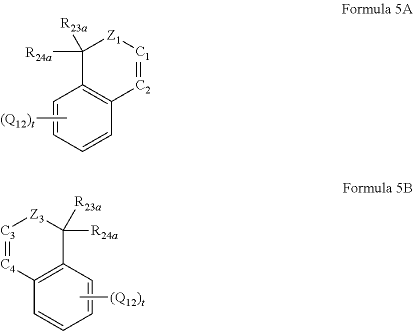
wherein, in Formulae 5A and 5B,
C₁, C₂, C₃, C₄, Z₁, and Z₃ are defined as in claim 1; and
R₂₃ₐ, R₂₄ₐ, and Q₁₂ are each independently selected from a hydrogen atom, a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, a C₂-C₁₀ alkenyl group, and -(Q₁)ᵣ-(Q₂)ₛ,
wherein
Q₁ is selected from —O—, —S—, —C(═O)—, a C₁-C₁₀ alkylene group, a C₆-C₁₄ arylene group, and a C₂-C₁₄ heteroarylene group;
Q₂ is selected from a deuterium atom, a halogen atom, a hydroxyl group, a cyano group, a nitro group, an azido group, an amino group, an amido group, an amidino group, a hydrazine group, a hydrazone group, a carboxyl group or a salt thereof, a sulfonic acid group or a salt thereof, a phosphoric acid group or a salt thereof, a thiol group, —C(═O)—H, a methyl group, an ethyl group, an n-propyl group, an isopropyl group, an n-butyl group, an isobutyl group, a sec-butyl group, a tert-butyl group, an n-pentyl group, an isopentyl group, a sec-pentyl group, a tert-pentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and a C₁-C₁₀ alkoxy group;
r and s are each independently an integer from 1 to 5; and
t is an integer from 1 to 4.

10. The electrolyte of claim 1, wherein the additive composition comprises at least one of Compounds 1 to 17:

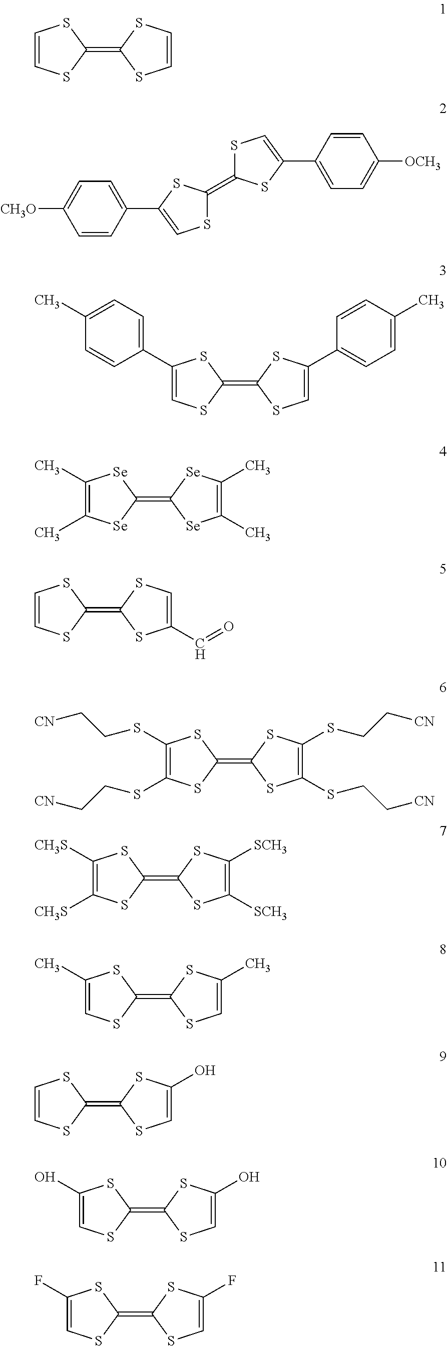

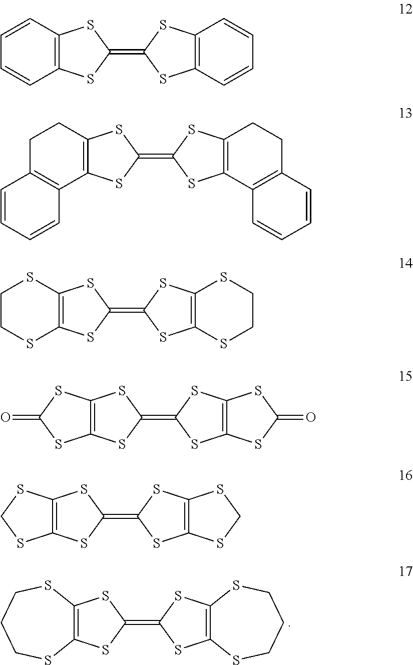

11. The electrolyte of claim 1, wherein the additive composition further comprises a phosphate represented by Formula 10: 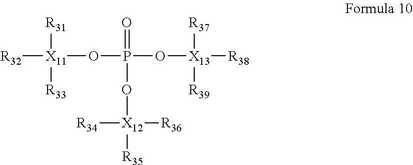
wherein, in Formula 10,
X₁₁ to X₁₃ are each independently Si, Ge, or Sn; and
R₃₁ to R₃₉ are each independently selected from a C₁-C₁₀ alkyl group, a C₂-C₁₀ alkenyl group, and a C₆-C₁₀ aryl group.

12. The electrolyte of claim 1, wherein an amount of the additive composition is from about 0.005 parts to about 5 parts by weight based on 100 parts by weight of a total weight of the electrolyte.

13. The electrolyte of claim 1, wherein the lithium salt comprises LiPF₆, LiBF₄, LiSbF₆, LiAsF₆, LiCF₃SO₃, L₁(CF₃SO₂)₃C, L₁(CF₃SO₂)₂N, LiC₄F₉SO₃, LiClO₄, LiAlO₄, LiAlCl₄, LiBPh₄, LiN(CₓF₂ₓ₊₁SO₂)(CₓF_{2y+1}SO₂) (where x and y are natural numbers), LiCl, LiI, lithium bisoxalate borate, or a combination thereof.

14. The electrolyte of claim 1, wherein the nonaqueous organic solvent is selected from at least one of a carbonate solvent, an ester solvent, an ether solvent, a ketone solvent, an alcohol solvent, and an aprotic bipolar solvent.

15. A lithium secondary battery comprising:
a cathode comprising a cathode active material that allows intercalation and deintercalation of lithium;
an anode comprising an anode active material that allows intercalation and deintercalation of lithium; and
an electrolyte disposed between the cathode and the anode,
wherein the electrolyte is the electrolyte of claim 1.

16. The lithium secondary battery of claim 15 further comprising a film disposed between the cathode and the electrolyte, wherein the film is derived from at least a part of the additive composition.

17. The lithium secondary battery of claim 15, wherein the cathode active material comprises LiCoO₂, LiNi_{1-X}Co_{X}O₂ (where 0≦x<1), L_{1-X}M_{X}O₂ (where M comprises at least one of Mn and Fe, and 0.03<x<0.1), Li[Ni_{X}Co_{1-2X}Mn_{X}]O₂ (where 0<x<0.5), Li[Ni_{X}Mn_{X}]O₂ (where 0<x≦0.5), Li₁₊ₓ(Ni,Co,Mn)_{1-y}O_{z} (where 0<x≦1, 0≦y<1, and 2≦z≦4), LiM₂O₄ (where M comprises at least one of Ti, V, and Mn), LiM_{X}Mn_{2-X}O₄ (where M is a transition metal), LiFePO₄, LiMPO₄ (where M comprises at least one of Mn, Co, and Ni), V₂O₅, V₂O₃, VO₂(B), V₆O₁₃, V₄O₉, V₃O₇, Ag₂V₄O₁₁, AgVO₃, LiV₃O₅, δ-Mn_{y}V₂O₅, δ-NH₄V₄O₁₀, Mn_{0.8}V₇O₁₆, LiV₃O₈, CuₓV₂O₅, CrₓV₆O₁₃, M₂(XO₄)₃ (where M is a transition metal; and X comprises at least one of S, P, As, Mo, and W), or Li₃M₂(PO₄)₃ (where M comprises at least one of Fe, V, and Ti).

18. The lithium secondary battery of claim 15, wherein the cathode active material comprises Li₁₊ₓM₁₋ₓO₂ (where M comprises at least one of Ni, Co, and Mn, and 0.05≦x≦0.2), or LiNi_{0.5}Mn_{1.5}O₄.

19. The lithium secondary battery of claim 15, wherein the anode active material comprises at least one of a material selected from vanadium oxide, lithium vanadium oxide, Si, SiOₓ (where 0<x<2), a Si—Y alloy (where Y is Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof), graphite, soft carbon, hard carbon, meso-phase pitch carbides, and sintered corks.

20. The lithium secondary battery of claim 15 further comprising a separator disposed between the cathode and the anode, wherein the separator electrically insulates the cathode from the anode.
